(19) United States
(12) Patent Application Publication
(10) Pub. No.: US 2003/0118418 A1
(43) Pub. Date: Jun. 26, 2003

(54) NC helical broaching machine improved in broach driving

(76) Inventors: Shinzi Kinoshita, Namekawa-shi (JP); Koji Takeda, Toyama-shi (JP)

Correspondence Address: VENABLE, BAETJER, HOWARD AND CIVILETTI, LLP, P.O. BOX 34385, WASHINGTON, DC, 20043-9998, US

(21) Appl. No.: 10/326,665

(22) Filed: Dec. 23, 2002

(30) Foreign Application Priority Data
Dec. 26, 2001 (JP) 2001-394723
Nov. 8, 2002 (JP) 2002-324999

(51) Int. Cl. B23D 37/16

(52) U.S. Cl. 409/270

(57) ABSTRACT

A broaching machine is of a work-moving type in which a broach is rotatively driven while a work held on a ram is pushed up against the broach to perform broaching of the work. The broach is driven at the front end shank and the rear end shank in synchronism with each other under the control of an NC controller. The work and the ram are adapted to be moved vertically (in a Y-axis direction). This construction frees the broach from any torsion and improves a machining accuracy.

### BACKGROUND OF THE INVENTION

The present invention relates to an NC helical broaching machine and more particularly to a work-moving type NC helical broaching machine.

A conventional work-moving type NC helical broaching machines is constructed to push up a work by means of a table and rotatively drive a broach at only the front end shank thereof to effect broaching on the work. Such a broaching machine has been disclosed in, for instance, JP-A-61-203220. A conventional cutter-moving type broaching machine, in which a work position is fixed, is constructed to hold a work on a fixed table and rotatively drive a broach at only its rear end shank to perform broaching on the work.

In the conventional NC helical broaching machine that rotatively drives only the front end shank of the broach, finishing teeth of the broach are remote from the front end shank that is drivingly supported. Hence, during a finishing process, the broach is twisted under a cutting load, degrading a machining accuracy. In the helical broaching machine that rotatively drives only the rear end shank of the broach, the finishing teeth are embedded into shell teeth of the broach. Thus, the broach body is narrow and is easily twisted, degrading the machining accuracy.

### BRIEF SUMMARY OF THE INVENTION

It is an object of the present invention to provide an NC helical broaching machine, which does not cause any torsion to a broach itself and has an improved machining accuracy.

The work-moving type NC helical broaching machine according to the invention comprises a drive mechanism adapted to grip and rotate a front end shank and a rear end shank of a broach, and an NC controller operating the mechanism and features rotating the front end shank and the rear end shank of the broach in synchronism with each other to cut a work.

With this construction, the finishing teeth portion on the rear end shank side of the broach rotates in synchronism with the front end shank. Thus, the broach is prevented from being twisted and is free of any torsion, improving the machining accuracy.

This broaching machine preferably further comprises a ram movably provided to move the work along the broach and a servo motor connected to the ram for driving thereof, wherein the drive mechanism includes a servo motor for rotating the front end shank and another servo motor for rotating the rear end shank. The ram and the servo motors can be synchronously driven under the control of the NC controller to easily realize the aforementioned effects and advantages of the invention.

Preferably, the broaching machine further comprises a column and a lifter mounted on the column, and the drive mechanism includes a rear end shank chuck for holding the rear end shank of the broach and a main spindle connected to the chuck. The main spindle is supported rotatably and vertically movably on the lifter, and the servo motor for rotating the rear end shank is installed above the lifter to rotate the rear end shank chuck through the main spindle. With this construction, the main spindle and the rear end shank chuck can be vertically moved by the lifter to facilitate the replacement of the broach.

The work-moving type NC helical broaching machine according to another aspect of the invention comprises a ram movable to hold a work and move it along a broach, a first chuck to hold the broach on one side of the ram and rotate the broach, a second chuck to hold the broach on the other side of the ram to rotate broach, which is movable toward or away from the first chuck, and an NC controller to operate the ram and the first and second chucks so that the broach rotates by synchronous driving on the both sides of the ram to process the work.

### BRIEF DESCRIPTION OF THE DRAWING

The above and other objects, features and advantages of the invention will become apparent from the following description of the embodiment of the invention taken in conjunction with the accompanying drawing, in which:

FIG. 1 is a schematic perspective view of the NC helical broaching machine according to an embodiment of the invention.

### DETAILED DESCRIPTION OF THE INVENTION

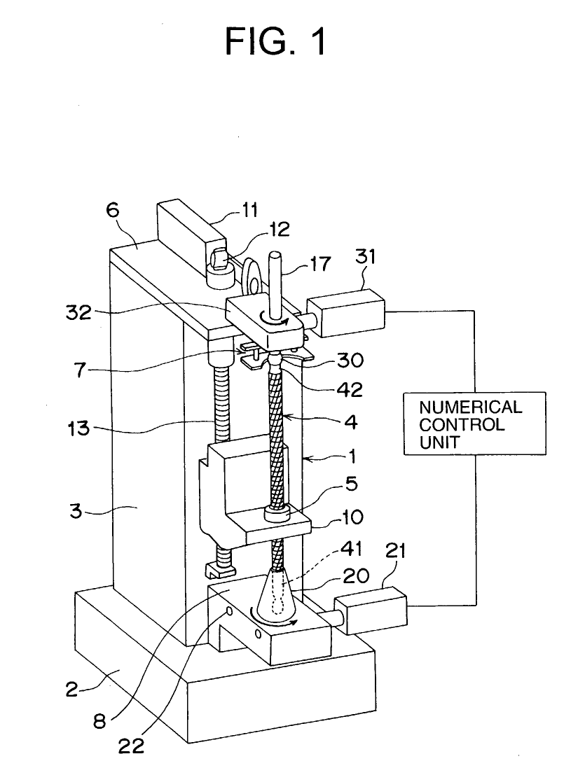

FIG. 1 shows the NC helical broaching machine 1 according to an embodiment of the invention. This broaching machine 1 has a base 2 and a column 3 securely mounted on the base 2. The column 3 is provided with a ram 10 that vertically moves along the column.

The ram 10 is adapted to be driven through a ball screw 13. An AC servo motor 11 for vertically driving the ram (in a Y-axis direction) is installed on a top portion 6 of the column. Also mounted are a worm reduction gear 12 for reducing an output speed of the servo motor 11 and a transmission device for coupling an output shaft of the worm reduction gear 12 to the ball screw 13, not shown.

The NC helical broaching machine 1 further -has a rear end shank chuck 30 and a front end shank chuck 20. These chucks are adapted to grip a rear end shank 42 of the broach 4 (upper side in FIG. 1) and a front end shank 41 (lower side in FIG. 1), respectively, and rotate them. The front end shank chuck 20 is rotatably supported on a support table 8 fixed to a lower portion of the column 3.

Fixedly mounted on the upper portion of the column 3 of the NC helical broaching machine 1 is a lifter 7 for vertically moving and rotatively driving the rear end shank chuck. The rear end shank chuck 30 is directly coupled to a main spindle 17 which is vertically movably and rotatably supported on the lifter 7. An AC servo motor 31 for driving the rear end shank chuck 30 and a double lead worm reduction gear 32 for reducing an output speed of this servo motor are mounted on the top portion 6 of the column to be situated above the lifter 7. The main spindle 17 and the double lead worm reduction gear 32 are coupled through a hydraulic drive clamping sleeve, not shown.

The front end shank chuck 20 on the support table 8 of the column 3 is coupled to an AC servo motor 21 for driving the front end shank chuck 20, a double lead worm reduction gear 22 for reducing the servo motor output speed and a transmission device, not shown. The transmission device connects the output shaft of the double lead worm reduction gear 22 to the front end shank chuck 20.

The NC helical broaching machine 1 according to this embodiment of the invention is of a work-moving type and is adapted to synchronously rotate the front end shank 41 and the rear end shank 42 of the broach 4 by an NC controller and at the same time move a work 5 vertically (in a Y-axis direction) by the ram 10.

In operation, the work 5 is secured on the ram 10 using a jig, not shown. At this time, the ram is located at a lower end position of its vertical stroke, i.e., at a home position. The broach 4 is held by the rear end shank chuck 30, which is supported through the main spindle 17 on the lifter 7, and is suspended therefrom. Then, the broach 4 is lowered by the driving of the lifter 7 and passed through a prepared hole formed in the work 5. In this state the front end shank 41 of the broach 4 is held by the front end shank chuck 20 on the support table 8.

Subsequently, under the control by the NC controller the AC servo motor 11 for the vertical driving of the ram is operated to move the ram 10 together with the work 5 upward. At the same time, the AC servo motor 21 for the front end shank chuck 20 (B-axis) and the AC servo motor 31 for the rear end shank chuck 30 (V-axis) are started to rotatively drive the front end shank 41 and rear end shank 42 of the broach 4. The driving of the front end shank and the rear end shank and the driving of the ram 10 are synchronized. As a result, the broach 4 is rotated in synchronism with the upward movement of the ram 10, thus performing broaching of the work 5.

Upon completion of the broaching on the work 5, the ram 10 is once stopped in the course of the upward movement and the rear end shank chuck 30 is opened to release the rear end shank 42 of the broach. Then, the ram 10 is moved to the upper limit of its stroke to allow the work 5 to disengage from the broach 4. In this state, the machined work 5 is pushed on the ram 10 toward the front thereof by a device not shown. Then, the ram 10 along with the work 5 is lowered to the home position. Next, the front end shank chuck 20 is opened to release the front end shank 41 of the broach. The rear end shank chuck 30 is then lowered by the driving of the lifter 7 and again holds the rear end shank 42 of the broach 4. The lifter 7 is operated to lift the broach 4 to a position above the work 5. In this condition an operator picks up the machined work 5, which has been pushed out on the ram. Now, one cycle of operation is finished and the next cycle of operation can be started.

As described above, the NC helical broaching machine 1 under the control of the NC controller simultaneously rotates the front end shank 41 and rear end shank 42 of the broach 4 while moving the work 5. Thus, the broach is rotatively driven at the both ends so that the finishing teeth portion rotates in synchronism with the front end shank. Therefore, the broach itself is not twisted, improving the machining accuracy.

In the NC helical broaching machine according to the embodiment of the invention, the servo motor for driving the work moving ram, the servo motor for rotating the front end shank and the servo motor for rotating the rear end shank can be driven in synchronism with each other very accurately by the NC controller. Accordingly, the broach itself is not twisted and is free from distortion. Further, the replacement of the broach can be facilitated by employing the construction, in which the rear end shank chuck 30 is directly coupled to the main spindle 17 to be lifted and lowered along with the main spindle 17 by the lifter, and the servo motor for rotating the rear end shank is installed above the lifter.

Although the foregoing description has been made on the embodiment of the invention, it will be understood that the invention is not limited solely to the specific form and that various changes and modifications may be made in the invention without departing from the spirit of the invention and the scope of the appended claims.

For example, although the NC helical broaching machine according to the embodiment of the invention as shown in FIG. 1 has been described as using AC servo motors in driving the ram and the broach, respectively, these motors may be substituted with DC servo motors. Further, instead of the worm reduction gears in the embodiment, any other appropriate reduction gear, such as gear trains and chain-sprockets, may be used.

What is claimed is:

1. A work-moving type NC helical broaching machine comprising:
a drive mechanism to grip and rotate a front end shank and a rear end shank of a broach; and
an NC controller to activate the driving mechanism to rotate the front end shank and the rear end shank of the broach in synchronism with each other to cut a work.

2. A NC helical broaching machine according to claim 1 further comprising a ram movably provided to move the work along the broach and a servo motor for driving connected to the ram, wherein the drive mechanism includes a servo motor for rotating the front end shank and another servo motor for rotating the rear end shank.

3. A NC helical broaching machine according to claim 2 further comprising a column and a lifter mounted on the column, wherein the drive mechanism includes a rear end shank chuck for holding the rear end shank of the broach and a main spindle connected to the chuck, the main spindle is supported rotatably and vertically movably on the lifter, and the servo motor for rotating the rear end shank is installed above the lifter to rotate the rear end shank chuck through the main spindle.

4. A work-moving type NC helical broaching machine comprising:
a ram movable to hold a work and move the work along a broach
a first chuck to hold the broach on one side of the ram and rotate the broach;
a second chuck to hold the broach on the other side of the ram to rotate the broach, the second chuck being movable toward or away from the first chuck; and
an NC controller to operate the ram and the first and second chucks so that the broach is driven to rotate simultaneously on both sides of the ram to machine the work.
